(19) United States
(12) Patent Application Publication
(10) Pub. No.: US 2026/0145463 A1
(43) Pub. Date: May 28, 2026

(54) POWER TRANSMISSION APPARATUS

(71) Applicant: HYUNDAI WIA Corporation, Changwon-si, Gyeongsangnam-do (KR)

(72) Inventor: Chung Heon HYUN, Uiwang-si (KR)

(73) Assignee: HYUNDAI WIA Corporation, Changwon-si, Gyeongsangnam-do (KR)

(21) Appl. No.: 19/385,648

(22) Filed: Nov. 11, 2025

(30) Foreign Application Priority Data
Nov. 25, 2024 (KR) 10-2024-0169679

(51) Int. Cl. B60B 35/12; F16D 3/223

(52) U.S. Cl. CPC B60B 35/128; F16D 3/223; F16D 2003/2232

(57) ABSTRACT

Disclosed is a power transmission apparatus including a constant velocity joint and a wheel hub. The power transmission apparatus includes a wheel hub, an outer race, a first inner race combined with the outer race to constitute a first constant velocity joint, a second inner race combined with the outer race to constitute a second constant velocity joint, a shaft coupled to the first inner race so as to transmit rotation to the first inner race, a stem coupled to the second inner race and the wheel hub so as to receive rotation from the second inner race and transmit the same to the wheel hub, and an elastic body configured to elastically support the stem or the shaft relative to the outer race.

### CROSS-REFERENCE TO THE RELATED APPLICATION

The present application claims priority to and the benefit of Korean Patent Application No. 10-2024-0169679, filed on Nov. 25, 2024, in the Korean Intellectual Property Office, the entire disclosure of which is incorporated herein by reference.

### BACKGROUND

### 1. Field

The present disclosure relates to a power transmission apparatus including a constant velocity joint and a wheel hub.

### 2. Description of the Related Art

Vehicles, such as purpose-built vehicles (PBVs), have a limited maximum articulation angle of approximately 54 degrees due to interference between an outer race and a shaft, resulting in a limited turning radius. Particularly, electrification and enlargement of PBVs are increasing the size of a wheelbase, which requires a larger turning radius. However, a conventional power transmission apparatus including a constant velocity joint and a wheel hub coupled to each other has the aforementioned limited maximum articulation angle, making it difficult to perform U-turns or park PBVs.

The above information disclosed in this Background section is for enhancement of understanding of the background of the present disclosure, and therefore, it may contain information that does not constitute related (or prior) art.

### SUMMARY

An aspect of the present disclosure is to provide a power transmission apparatus capable of reducing the turning radius by increasing the wheel steering angle.

A power transmission apparatus according to an embodiment of the present disclosure includes a wheel hub, an outer race, a first inner race combined with the outer race to constitute a first constant velocity joint, a second inner race combined with the outer race to constitute a second constant velocity joint, a shaft coupled to the first inner race so as to transmit rotation to the first inner race, a stem coupled to the second inner race and the wheel hub so as to receive rotation from the second inner race and to transmit the same to the wheel hub, and an elastic body configured to elastically support the stem or the shaft relative to the outer race.

The power transmission apparatus may further include a support plate fixed to the outer race, wherein the elastic body may elastically supports the stem or the shaft relative to the support plate.

The elastic body may be a coil spring.

The power transmission apparatus may further include a fixing portion fixed to the outer race, wherein the elastic body may be fixed to the fixing portion to elastically support the stem or the shaft.

The elastic body may be made of rubber or plastic.

Each of the first and second constant velocity joints may be implemented as a fixed ball type constant velocity joint or a sliding ball type constant velocity joint.

One of the first and second constant velocity joints may be implemented as a fixed ball type constant velocity joint, and the other may be implemented as a sliding ball type constant velocity joint.

The first and second constant velocity joints may have different sizes.

### BRIEF DESCRIPTION OF THE DRAWINGS

The accompanying drawings, which are incorporated in this specification, illustrate exemplary embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a sectional view of a power transmission apparatus according to an embodiment of the present disclosure;

FIG. 2 is a perspective view of an outer race of the power transmission apparatus according to the embodiment of the present disclosure;

FIG. 3 is a sectional view taken along line A-A of FIG. 2;

FIG. 4 is a perspective view of a stem of the power transmission apparatus according to the embodiment of the present disclosure;

FIG. 5 is a view showing a support plate and an elastic body of the power transmission apparatus according to the embodiment of the present disclosure;

FIG. 6 is a sectional view of a power transmission apparatus according to another embodiment of the present disclosure;

FIG. 7 is a sectional view of a power transmission apparatus according to another embodiment of the present disclosure; and

FIG. 8 is a view showing an elastic body of the power transmission apparatus according to the embodiment of the present disclosure.

### DETAILED DESCRIPTION OF EXEMPLARY EMBODIMENTS

Embodiments of the present disclosure are provided to more fully illustrate the present disclosure to a person having ordinary skill in the art, the following embodiments may be modified in various other forms, and the scope of the present disclosure is not limited to the following embodiments. The embodiments are provided to make the present disclosure more faithful and complete and to completely convey the idea of the present disclosure to those skilled in the art.

Exemplary embodiments of the present disclosure will now be described in detail with reference to the accompanying drawings such that a person having ordinary skill in the art to which the present disclosure pertains can easily practice the present disclosure.

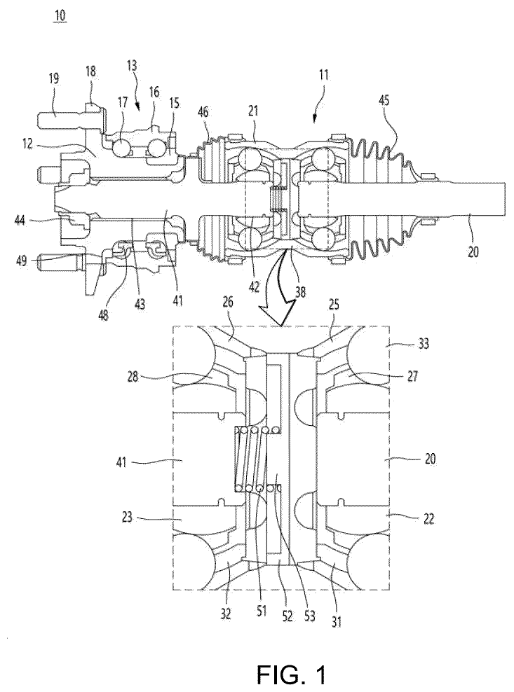

Referring to FIG. 1, the power transmission apparatus 10 may include a constant velocity joint 11 and a wheel hub 12. The wheel hub 12 may be rotatably supported by a rolling bearing 13. The rolling bearing 13 may include an inner ring 15, an outer ring 16, and bearing balls 17 disposed between the inner ring 15 and the outer ring 16. The rolling bearing 13 may also include a retainer 48 and a seal 49. The wheel hub 12 may include a flange 18 extending radially outward, and may transmit power via a bolt 19 coupled to the flange 18. The power transmission apparatus 10 may transmit rotational power transmitted via the shaft 20 to the bolt 19 via the constant velocity joint 11 and the wheel hub 12.

The constant velocity joint 11 may be configured with one outer race 21 and two inner races 22 and 23 combined to perform two independent articulations. That is, the constant velocity joint 11 may be configured to implement two constant velocity joints while sharing one outer race 21. As a result, the constant velocity joint 11 may have a maximum articulation angle corresponding to the sum of the two articulation angles. This may significantly increase the resulting maximum articulation angle, leading to an increase in the maximum steering angle. The constant velocity joint 11 may be implemented as a fixed ball type joint, where the constant velocity joint is articulated in a state of being axially fixed in position, or as a sliding ball type joint, where the constant velocity joint is articulated while axially sliding along a track groove of the outer race 21.

Referring to FIGS. 1 to 3, the outer race 21 may have a plurality of first outer ball grooves 25 and a plurality of second outer ball grooves 26 formed respectively in inner circumferential surfaces of both sides thereof in a longitudinal direction. The first outer ball groove 25 may pair with a first inner ball groove 27 formed in an outer circumferential surface of the inner race on the right side, i.e., the first inner race 22, in FIG. 1, and the second outer ball groove 26 may pair with a second inner ball groove 28 formed in an outer circumferential surface of the inner race on the left side, i.e., the second inner race 23, in FIG. 1. A first ball cage 31 may be disposed between an inner circumferential surface of the right side of the outer race 21 and the first inner race 22, and a second ball cage 32 may be disposed between an inner circumferential surface of the left side of the outer race 21 and the second inner race 23. The first and second ball cages 31 and 32 may have windows configured to receive balls 33 and 34, respectively, and the balls 33 and 34 may be received in a space formed by the first outer ball groove 25 and the first inner ball groove 27 and a space formed by the second outer ball groove 26 and the second inner ball groove 28, respectively, in a state of being received in the windows formed in the first and second ball cages 31 and 32, respectively. This may implement two constant velocity joint structures sharing the outer race 21.

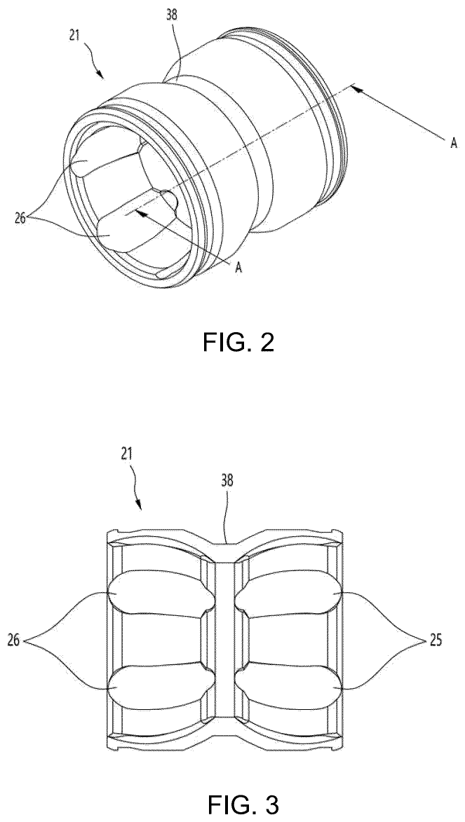

Referring to FIGS. 2 and 3, the outer race 21 may be provided in the center in the longitudinal direction with a recess 38, which is an inwardly recessed portion, and the first and second outer grooves 25 and 26 may be disposed on both sides of the recess 38 in a separated state.

A shaft 20 configured to receive power generated by a power source of a vehicle, such as a transmission or a motor, may be fastened to the first inner race 22. The shaft 20 may be coupled to the first inner race 22 by spline coupling, whereby the rotation of the shaft 20 may be transmitted to the first inner race 22. The rotation of the first inner race 22 may be transmitted to the outer race 21 via the balls 33, and the rotation of the outer race 21 may be transmitted to the first inner race 23 via the balls 34.

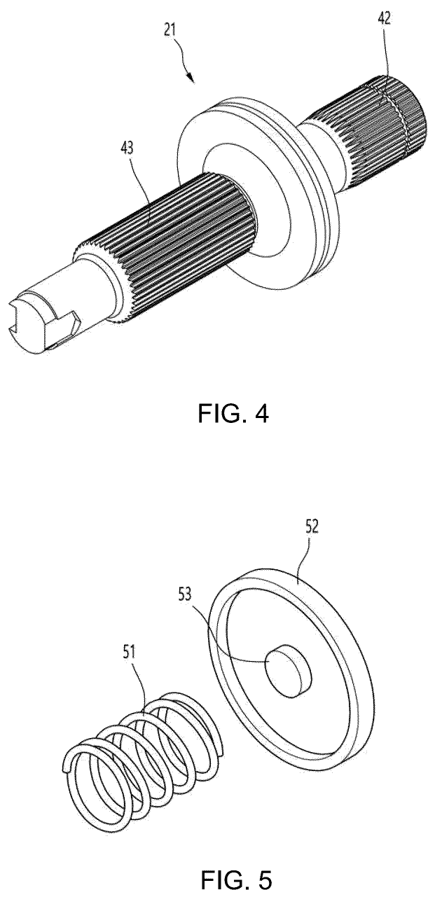

Referring to FIG. 4, a stem 41 may be provided with two spline structures 42 and 43, and may be spline-coupled respectively to the second inner race 23 and the wheel hub 12 via the spline structures 42 and 43. The stem 41 may be spline-coupled to the second inner race 23 via the spline structure 42 provided at one end thereof, whereby the rotation of the second inner race 23 may be transmitted to the stem 41. The stem 41 may be spline-coupled to the wheel hub 12 via the other spline structure 43, whereby the rotation of the stem 41 may be transmitted to the wheel hub 12. One end of the stem 41 may be exposed outside the wheel hub 12, where a wheel nut 44 may be coupled to fix the stem 41 and the wheel hub 12.

Boots 45 and 46 configured to seal grease filling the outer race 21 may be fastened between one end of the outer race 21 and the shaft 20 and between the other end of the outer race 21 and the stem 41, respectively.

In the embodiment of the present disclosure, the articulation between the outer race 21 and the shaft 20 and the articulation between the outer race 21 and the stem 41 may be independently performed, and the constant velocity joint 11 may have the maximum articulation angle corresponding to the sum of the two articulation angles.

The stem 41 may be elastically supported relative to the outer race 21 by an elastic body 51. Referring to FIGS. 1 and 5, a support plate 52 may be fixed to an inner surface of the outer race 21, and the elastic body 51 may elastically support the stem 41 relative to the support plate 52. The elastic body 51 may be a coil spring, and may be disposed in a compressed state to support the stem 41 in a direction away from the support plate 52. In this case, an elastic body support portion 53 may be formed so as to protrude from the support plate 52 toward the stem 41. As a result, the stem 41 may be elastically supported relative to the outer race 21 by the elastic body 51. Consequently, during articulation, articulation between the outer race 21 and the stem 41 may be limited by the elastic force of the elastic body 51, whereby articulation between the outer race 21 and the shaft 20 may be performed, and then articulation between the outer race 21 and the stem 41 may be performed. During restoration, articulation between the outer race 21 and the stem 41 may be restored, and articulation between the outer race 21 and the shaft 20 may be restored. As articulation and restoration are sequentially performed, as described above, a divergence phenomenon of the outer race (a state in which position control of the outer race is impossible) may be prevented.

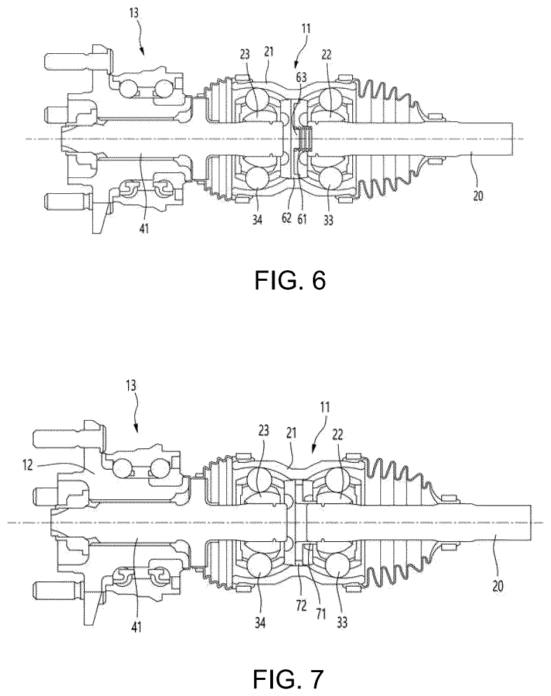

FIG. 6 is a sectional view of a power transmission apparatus according to another embodiment of the present disclosure. The embodiment shown in FIG. 6 is identical to the embodiment described above except that an elastic body 61 elastically supports a shaft 20 rather than a stem 41. Referring to FIG. 6, a support plate 62 may be fixed to an outer race 21, and the elastic body 61 may elastically support the shaft 20 relative to the support plate 62. In this case, an elastic body support portion 63 may be formed so as to protrude from the support plate 62 toward the shaft 20. Consequently, articulation and restoration may be performed in reverse order to the above-described embodiment.

In the other embodiment of the present disclosure, a constant velocity joint may be implemented by combining a fixed ball type joint and a sliding ball type joint. In another embodiment, a constant velocity joint may be implemented by combining two joints of different sizes.

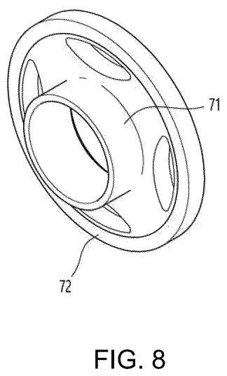

FIGS. 7 and 8 show a power transmission apparatus according to another embodiment of the present disclosure. FIG. 7 is a sectional view of a power transmission apparatus according to another embodiment of the present disclosure, and FIG. 8 is a view showing an elastic body of the power transmission apparatus according to the embodiment of the present disclosure. Referring to FIGS. 7 and 8, an elastic body 71 may be implemented using an elastic material, such as rubber or plastic, and the elastic body 71 may be fixed to a ring-shaped fixing portion 72 that is press-fitted into an outer race 21. The elastic body 71 may protrude toward a shaft 20 to elastically support the shaft 20 relative to the fixing portion 72. Consequently, the shaft 20 may be elastically supported relative to the outer race 21. Although FIGS. 7 and 8 illustrate the case in which the elastic body 71 protrudes toward the shaft 20 to elastically support the shaft 20, the elastic body may protrude toward a stem 41 to elastically support the stem 41.

The first constant velocity joint and the second constant velocity joint may have different sizes. For example, the outer race 21 may be configured to have different sizes on left and right sides of a recess 38. In this structure, the articulation angle between the outer race 21 and the shaft 20, and the articulation angle between the outer race 21 and the stem 41 may be different from each other, whereby the steering angle may be varied according to the design specifications.

According to embodiments of the present disclosure, the constant velocity joint may perform two independent articulations while sharing one outer race, whereby the resulting maximum articulation angle may be increased. Furthermore, the shaft or the stem may be elastically supported relative to the outer race, whereby articulation and restoration may be sequentially performed and therefore the divergence phenomenon of the outer race may be prevented.

The above is only an embodiment for implementing the present disclosure, the present disclosure is not limited to the above embodiment, and a person having ordinary skill in the art to which the present disclosure pertains will recognize the technical spirit of the present disclosure to the extent that various modifications can be made without departing from the gist of the present disclosure as claimed in the following claims.

What is claimed is:

1. A power transmission apparatus comprising:
a wheel hub;
an outer race;
a first inner race combined with the outer race to constitute a first constant velocity joint;
a second inner race combined with the outer race to constitute a second constant velocity joint;
a shaft coupled to the first inner race so as to transmit rotation to the first inner race;
a stem coupled to the second inner race and the wheel hub so as to receive rotation from the second inner race and to transmit the same to the wheel hub; and
an elastic body configured to elastically support the stem or the shaft relative to the outer race.

2. The power transmission apparatus as claimed in claim 1, further comprising:
a support plate fixed to the outer race, wherein
the elastic body elastically supports the stem or the shaft relative to the support plate.

3. The power transmission apparatus as claimed in claim 2, wherein the elastic body is a coil spring.

4. The power transmission apparatus as claimed in claim 1, further comprising:
a fixing portion fixed to the outer race, wherein
the elastic body is fixed to the fixing portion to elastically support the stem or the shaft.

5. The power transmission apparatus as claimed in claim 4, wherein the elastic body is made of rubber or plastic.

6. The power transmission apparatus as claimed in claim 1, wherein
each of the first and second constant velocity joints are implemented as a fixed ball type constant velocity joint or a sliding ball type constant velocity joint.

7. The power transmission apparatus as claimed in claim 6, wherein
one of the first and second constant velocity joints are implemented as a fixed ball type constant velocity joint, and
the other is implemented as a sliding ball type constant velocity joint.

8. The power transmission apparatus as claimed in claim 6, wherein the first and second constant velocity joints have different sizes.
